(19) United States
(12) Patent Application Publication
(10) Pub. No.: US 2026/0288407 A1
(43) Pub. Date: Sep. 24, 2026

(54) USER TERMINAL AND CONTROL METHOD THEREOF

(71) Applicant: LG ELECTRONICS INC., Seoul (KR)

(72) Inventors: Jaejun LEE, Seoul (KR); Taehyoung KIM, Seoul (KR); Jonghwa SHIN, Seoul (KR); Hyungsuk LEE, Seoul (KR); Seunghee SEO, Seoul (KR); Sunghoon CHO, Seoul (KR)

(73) Assignee: LG ELECTRONICS INC., Seoul (KR)

(21) Appl. No.: 19/683,342

(22) Filed: May 20, 2026

Related U.S. Application Data
(63) Continuation of application No. PCT/KR2024/008517, filed on Jun. 20, 2024.

(51) Int. Cl. G06F 3/14; G06F 3/04812; G06F 21/31; H04W 4/80

(52) U.S. Cl. CPC G06F 3/1446; G06F 3/04812; G06F 21/31; H04W 4/80

(57) ABSTRACT

A method for controlling a main user terminal can include establishing a first communication connection between the main user terminal and an external user terminal for transmitting screen data, establishing a second communication connection between the main user terminal and the external user terminal for transmitting control data, in response to determining that an input routing condition is met for directing control to the external user terminal, obtaining an input event generated by an input device connected to the main user terminal, and transmitting data corresponding to the input event from the main user terminal to the external user terminal via the second communication connection for enabling the external user terminal to execute an operation corresponding to the input event.

### CROSS-REFERENCE TO RELATED APPLICATIONS

This application is a Continuation of International Application No. PCT/KR 2024/008517, filed on Jun. 20, 2024, the entire contents of which are hereby incorporated by reference.

### BACKGROUND

### Field

The present disclosure relates to a user terminal capable of sharing an input device with another user terminal, and more specifically, to a control method for controlling each of a plurality of user terminals connected to each other through communication using a single input device.

### Discussion of the Related Art

User terminals can be generally classified as mobile/portable terminals or stationary terminals according to their mobility. User terminals can also be classified as handheld terminals or vehicle mounted terminals according to whether or not a user can directly carry the terminal.

User terminals have become increasingly more functional. Examples of such functions include data and voice communications, capturing images and video via a camera, recording audio, playing music files via a speaker system, and displaying images and video on a display. Some user terminals include additional functionality which supports game playing, while other terminals are configured as multimedia players. More recently, user terminals have been configured to receive broadcast and multicast signals which permit viewing of content such as videos and television programs.

User terminals can be configured as multimedia players capable of performing various functions such as capturing images and video, recording audio, playing music files and outputting music, displaying images and videos, playing games, receiving broadcasts, and so on.

A user terminal can be communicatively connected to other user terminals in a wired manner and/or wirelessly. A separate input device (e.g., a human interface device (HID) such as a keyboard and a mouse) can be connected to each of a plurality of user terminals that are communicatively connected to one another.

However, when each user terminal is equipped with its own input device, providing a plurality of input devices for all user terminals can incur significant costs. Moreover, in this situation, the fact that a user should selectively use only a corresponding input device to control each specific user terminal can cause inconvenience to the user.

That is not to say that it is impossible to use only one input device for each of the plurality of user terminals. However, using one input device by connecting it to one user terminal, then disconnecting it and reconnecting it to another user terminal, can also cause inconvenience to the user.

For example, managing multiple independent computing devices often results in inefficiency and workspace clutter. Existing control solutions typically require redundant peripheral input devices, cumbersome hardware switches, or complex software configurations. Further, conventional software approaches frequently fail to adequately isolate user inputs, which can lead to unintended command executions on a primary device when a user attempts to control a secondary terminal.

Thus, a need exists for an improved method and system that enables a user to seamlessly control one or more external computing devices using the native input devices of a primary computing device. Such a solution is needed to reliably route input commands to the external device while effectively preventing unintended local execution. Further, there is a need for a comprehensive framework that seamlessly bridges multiple computing environments to provide a robust, reliable and uncluttered multi-device control experience.

### SUMMARY OF THE DISCLOSURE

An object of the present disclosure is to address the above-mentioned problems and to provide a user terminal capable of conveniently and quickly controlling each of a plurality of communicatively connected user terminals using a single input device, and a method for controlling the same.

To achieve the above object, the present disclosure can provide a user terminal including an input device, a display, a communication unit for a first communication connection and a second communication connection to a first external user terminal, and a controller controlling to generate a first screen and an extended screen of the first screen, display the first screen on the display, transmit the extended screen to the first external user terminal through the first communication connection, and transmit virtual coordinate information of the input device and a user command input through the input device to the first external user terminal through the second communication connection.

The controller can receive display identification data from the first external user terminal through the first communication connection.

The controller can control the generation of the extended screen based on a display resolution in the display identification data.

The controller can control to receive an IP address and a product unique identifier of the first external user terminal from the first external user terminal through a wireless network, and when the received product unique identifier is identical to a product unique identifier in the display identification data, match the IP address to the first external user terminal.

The controller can control to perform PIN code authentication with the first external user terminal using the IP address, receive a client key code for automatic connection from the first external user terminal, and establish the second communication connection with the first external user terminal using the client key code for automatic connection.

The controller can control to receive a mode state notification from the first external user terminal, when the first external user terminal is identified as operating as a main device through the mode state notification, request the first external user terminal to create an input communication channel in the second communication connection, and transmit the virtual coordinate information of the input device and the user command input through the input device to the first external user terminal through the input communication channel.

The extended screen can serve as a coordinate system for virtual coordinates.

The controller can control to establish a first communication connection and a second communication connection with a second external user terminal, while the first communication connection and the second communication connection are established with the first external user terminal.

The first communication connection can be a high definition multimedia interface (HDMI) or DisplayPort (DP) connection, and the second communication connection can be a Wi-Fi communication connection.

Further, to achieve the above object, the present disclosure can provide a user terminal including an input device, a display, a communication unit for a first communication connection and a second communication connection to an external user terminal, and a controller controlling to, when operating in a second mode, display an extended screen received from the external user terminal through the first communication connection on the display, in which the extended screen is capable of including a first pointer, and when operating in a first mode, display a second screen on the display, and generate and display a second pointer on the second screen based on virtual coordinate information received through the second communication connection.

The controller can control to create an input communication channel in response to an input communication channel creation request received from the external user terminal through the second communication connection, and to transmit information about the created input communication channel to the external user terminal.

The controller can control to perform an operation according to a user command received through the input communication channel.

The controller can control to transmit a mode state notification to the external user terminal, whenever mode switching is performed between the first mode and the second mode.

Further, to achieve the above object, the present disclosure can provide a method for controlling a user terminal, including establishing a first communication connection and a second communication connection with a first external user terminal, generating a first screen and displaying the first screen on a display, generating an extended screen of the first screen and transmitting the extended screen to the external user terminal through the first communication connection, and transmitting virtual coordinate information of an input device and a user command input through the input device to the external user terminal through the second communication connection.

Further, to achieve the above object, the present disclosure can provide a method for controlling a user terminal, including establishing a first communication connection and a second communication connection with an external user terminal, when operating in a second mode, displaying an extended screen received from the external user terminal through the first communication connection on a display, in which the extended screen is capable of including a first pointer, and when operating in a first mode, displaying a second screen on the display, and generating and displaying a second pointer on the second screen based on virtual coordinate information received through the second communication connection.

A user terminal and a method for controlling the same according to the present disclosure have the following effects.

According to at least one of the embodiments of the present disclosure, a single input device can efficiently control each of a plurality of user terminals, thereby obviating the need for providing a plurality of input devices for all of the plurality of user terminals.

Further, according to at least one of the embodiments of the present disclosure, a user can control each of a plurality of user terminals with a single input device, thereby enabling convenient and quick control of each of the plurality of user terminals.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a block diagram illustrating a user terminal according to an aspect of the present disclosure.

FIG. 2 illustrates a plurality of user terminals communicatively connected to each other according to an aspect of the present disclosure.

FIG. 3 illustrates an example in which a user terminal operates as a sub-device according to an aspect of the present disclosure.

FIGS. 4 and 5 illustrate examples in which a user terminal operates as a main device according to an aspect of the present disclosure.

FIG. 6 illustrates a communication connection process between a plurality of user terminals according to an aspect of the present disclosure.

FIG. 7 illustrates a mode switching process of a user terminal according to an aspect of the present disclosure.

FIGS. 8 and 9 illustrate a plurality of user terminals communicatively connected to each other according to an aspect of the present disclosure.

### DETAILED DESCRIPTION OF THE EMBODIMENTS

Description will now be given in detail according to example embodiments disclosed herein, with reference to the accompanying drawings. For the sake of brief description with reference to the drawings, the same or equivalent components can be provided with the same reference numbers, and description thereof will not be repeated. In general, a suffix such as “module” and “unit” can be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Each of these components can be configured as a separate individual hardware module or implemented as two or more hardware modules. Two or more components can be implemented as a single hardware module. In some situations, at least one of these components can be implemented as software.

It will be understood that although the terms first, second, etc. can be used herein to describe various elements, these elements should not be limited by these terms. These terms are generally only used to distinguish one element from another.

It will be understood that when an element is referred to as being “connected with” another element, the element can be connected with the other element or intervening elements can also be present. In contrast, when an element is referred to as being “directly connected with” another element, there are no intervening elements present.

A singular representation can include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps can likewise be utilized.

In this disclosure, the expression “at least one of A or B” can mean “A,” “B,” or “A and B.”

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “can.”

User terminals presented herein can be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of user terminals. However, such teachings apply equally to other types of terminals, such as those types noted above. In addition, these teachings can also be applied to stationary terminals such as digital TV, desktop computers, digital signages, and the like.

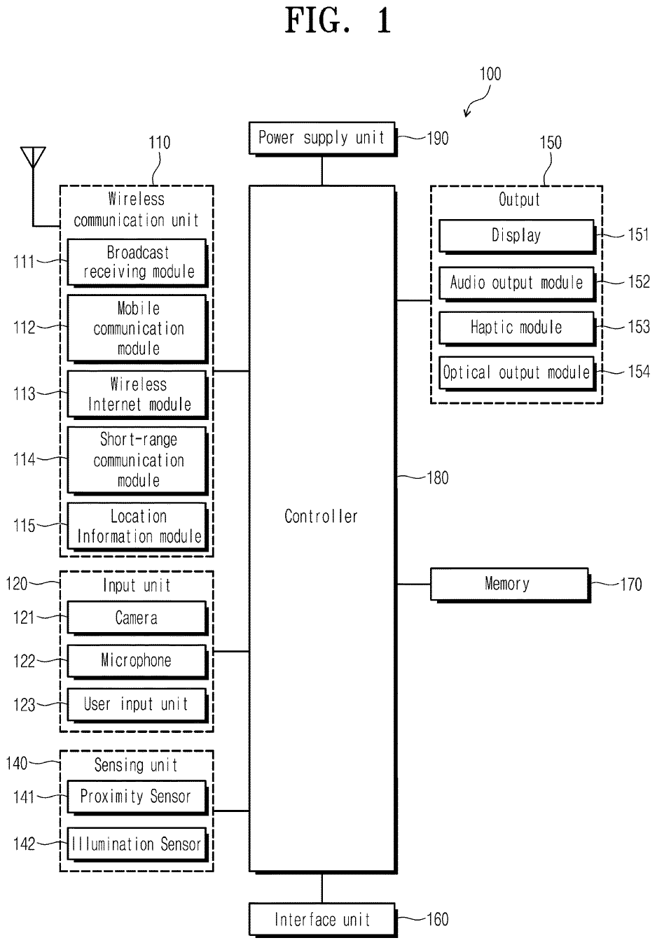

Reference is now made to FIG. 1, which is a block diagram of a user terminal in accordance with an aspect of the present disclosure.

The user terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components can alternatively be implemented.

Referring now to FIG. 1, the user terminal 100 is shown having wireless communication unit 110 configured with several commonly implemented components. For instance, the wireless communication unit 110 typically includes one or more components which permit wireless communication between the user terminal 100 and a wireless communication system or network within which the user terminal is located.

The wireless communication unit 110 typically includes one or more modules which permit communications such as wireless communications between the user terminal 100 and a wireless communication system, communications between the user terminal 100 and another user terminal, communications between the user terminal 100 and an external server. Further, the wireless communication unit 110 typically includes one or more modules which connect the user terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (e.g., a touch key, a push key, a mechanical key, a soft key, and the like) for allowing a user to input information. Data (e.g., audio, video, image, and the like) is obtained by the input unit 120 and can be analyzed and processed by controller 180 according to device parameters, user commands, and combinations thereof.

The sensing unit 140 is typically implemented using one or more sensors configured to sense internal information of the user terminal, the surrounding environment of the user terminal, user information, and the like. For example, in FIG. 1, the sensing unit 140 is shown having a proximity sensor 141 and an illumination sensor 142.

If desired, the sensing unit 140 can alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (e.g., camera 121), a microphone 122, a battery gauge, an environment sensor (e.g., a barometer, a hygrometer, a thermometer, a radiation detection sensor, a thermal sensor, and a gas sensor, among others), and a chemical sensor (e.g., an electronic nose, a health care sensor, a biometric sensor, and the like), to name a few. The user terminal 100 can be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 can have an inter-layered structure or an integrated structure with a touch sensor in order to facilitate a touch screen. The touch screen can provide an output interface between the user terminal 100 and a user, as well as function as the user input unit 123 which provides an input interface between the user terminal 100 and the user.

The interface unit 160 serves as an interface with various types of external devices that can be coupled to the user terminal 100. The interface unit 160, for example, can include any of wired or wireless ports, external power supply ports, wired or wireless data ports, memory card ports, ports for connecting a device having an identification module, audio input/output (I/O) ports, video I/O ports, earphone ports, and the like. In some situations, the user terminal 100 can perform assorted control functions associated with a connected external device, in response to the external device being connected to the interface unit 160.

The memory 170 is typically implemented to store data to support various functions or features of the user terminal 100. For instance, the memory 170 can be configured to store application programs executed in the user terminal 100, data or instructions for operations of the user terminal 100, and the like. Some of these application programs can be downloaded from an external server via wireless communication. Other application programs can be installed within the user terminal 100 at time of manufacturing or shipping, which is typically the situation for basic functions of the user terminal 100 (e.g., receiving a call, placing a call, receiving a message, sending a message, and the like). It is common for application programs to be stored in the memory 170, installed in the user terminal 100, and executed by the controller 180 to perform an operation (or function) for the user terminal 100.

The controller 180 typically functions to control overall operation of the user terminal 100, in addition to the operations associated with the application programs. The controller 180 can provide or process information or functions appropriate for a user by processing signals, data, information and the like, which are input or output by the various components depicted in FIG. 1, or activating application programs stored in the memory 170. As one example, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the user terminal 100. The power supply unit 190 can include a battery, and the battery can be configured to be embedded in the terminal body, or configured to be detachable from the terminal body.

At least some of the components can operate in cooperation with each other to implement an operation, control, or a control method of the user terminal according to various embodiments to be described below. In addition, the operation, the control, or the control method of the user terminal can be implemented on the user terminal by driving at least one application program stored in the memory 170.

Referring still to FIG. 1, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel can include a satellite channel, a terrestrial channel, or both. In some embodiments, two or more broadcast receiving modules 111 can be utilized to facilitate simultaneously receiving of two or more broadcast channels, or to support switching among broadcast channels.

The broadcast managing entity can be implemented using a server or system which generates and transmits a broadcast signal and/or broadcast associated information, or a server which receives a pre-generated broadcast signal and/or broadcast associated information, and sends such items to the user terminal. The broadcast signal can be implemented using any of a TV broadcast signal, a radio broadcast signal, a data broadcast signal, and combinations thereof, among others. The broadcast signal in some situations can further include a data broadcast signal combined with a TV or radio broadcast signal.

The broadcast signal can be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information can include information associated with a broadcast channel, a broadcast program, a broadcast event, a broadcast service provider, or the like. The broadcast associated information can also be provided via a mobile communication network, and in this situation, received by the mobile communication module 112.

The broadcast associated information can be implemented in various formats. For instance, broadcast associated information can include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 can be stored in a suitable device, such as a memory 170.

The mobile communication module 112 can transmit and/or receive wireless signals to and from one or more network entities. Typical examples of a network entity include a base station, an external user terminal, a server, and the like. Such network entities form part of a mobile communication network, which is constructed according to technical standards or communication methods for mobile communications (e.g., Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE), LTE-A(Long Term Evolution-Advanced), 5G, and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module can be internally or externally coupled to the user terminal 100. The wireless Internet module 113 can transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 can transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A, 5G and the like, as part of a mobile communication network, the wireless Internet module 113 performs such wireless Internet access. As such, the Internet module 113 can cooperate with, or function as, the mobile communication module 112.

The short-range communication module 114 is configured to facilitate short-range communications. Suitable technologies for implementing such short-range communications include BLUETOOTH, Radio Frequency IDentification (RFID), Infrared Data Association (IrDA), Ultra-WideBand (UWB), ZIGBEE, Near Field Communication (NFC), Wireless-Fidelity (Wi-Fi), Wi-Fi Direct, Wireless USB(Wireless Universal Serial Bus), and the like. The short-range communication module 114 in general supports wireless communications between the user terminal 100 and a wireless communication system, communications between the user terminal 100 and another user terminal 100, or communications between the user terminal and a network where another user terminal 100 (or an external server) is located, via wireless area networks. One example of the wireless area networks is a wireless personal area networks.

In some embodiments, another user terminal (which can be configured similarly to user terminal 100) can be a wearable device, for example, a smart watch, a smart glass or a head mounted display (HMD), which is able to exchange data with the user terminal 100 (or otherwise cooperate with the user terminal 100). The short-range communication module 114 can sense or recognize the wearable device, and permit communication between the wearable device and the user terminal 100. In addition, when the sensed wearable device is a device which is authenticated to communicate with the user terminal 100, the controller 180, for example, can cause transmission of data processed in the user terminal 100 to the wearable device via the short-range communication module 114. Hence, a user of the wearable device can use the data processed in the user terminal 100 on the wearable device. For example, when a call is received in the user terminal 100, the user can answer the call using the wearable device. Also, when a message is received in the user terminal 100, the user can check the received message using the wearable device.

The location information module 115 is generally configured to detect, calculate, derive or otherwise identify a position of the user terminal. As an example, the location information module 115 includes a Global Position System (GPS) module, a Wi-Fi module, or both. If desired, the location information module 115 can alternatively or additionally function with any of the other modules of the wireless communication unit 110 to obtain data related to the position of the user terminal. As one example, when the user terminal uses a GPS module, a position of the user terminal can be acquired using a signal sent from a GPS satellite. As another example, when the user terminal uses the Wi-Fi module, a position of the user terminal can be acquired based on information related to a wireless access point (AP) which transmits or receives a wireless signal to or from the Wi-Fi module.

The input unit 120 can be configured to permit various types of input to the user terminal 120. Examples of such input include audio, image, video, data, and user input. Image and video input is often obtained using one or more cameras 121. Such cameras 121 can process image frames of still pictures or video obtained by image sensors in a video or image capture mode. The processed image frames can be displayed on the display unit 151 or stored in memory 170. In some situations, the cameras 121 can be arranged in a matrix configuration to permit a plurality of images having various angles or focal points to be input to the user terminal 100. As another example, the cameras 121 can be located in a stereoscopic arrangement to acquire left and right images for implementing a stereoscopic image. The plurality of cameras 121 can include a depth camera and/or a time of flight (TOF) camera for three-dimensionally sensing a subject.

The microphone 122 is generally implemented to permit audio input to the user terminal 100. The audio input can be processed in various manners according to a function being executed in the user terminal 100. If desired, the microphone 122 can include assorted noise removing algorithms to remove unwanted noise generated in the course of receiving the external audio.

The user input unit 123 is a component that permits input by a user. Such user input can enable the controller 180 to control operation of the user terminal 100. The user input unit 123 can include one or more of a mechanical input element (e.g., a key, a button located on a front and/or rear surface or a side surface of the user terminal 100, a dome switch, a jog wheel, a jog switch, and the like), or a touch-sensitive input, among others. As one example, the touch-sensitive input can be a virtual key or a soft key, which is displayed on a touch screen through software processing, or a touch key which is located on the user terminal at a location that is other than the touch screen. On the other hand, the virtual key or the visual key can be displayed on the touch screen in various shapes, for example, graphic, text, icon, video, or a combination thereof.

The sensing unit 140 is generally configured to sense one or more of internal information of the user terminal, surrounding environment information of the user terminal, user information, or the like. The controller 180 generally cooperates with the sending unit 140 to control operation of the user terminal 100 or execute data processing, a function or an operation associated with an application program installed in the user terminal based on the sensing provided by the sensing unit 140. The sensing unit 140 can be implemented using any of a variety of sensors, some of which will now be described in more detail.

The proximity sensor 141 can include a sensor to sense presence or absence of an object approaching a surface, or an object located near a surface, by using an electromagnetic field, infrared rays, or the like without a mechanical contact. The proximity sensor 141 can be arranged at an inner region of the user terminal covered by the touch screen, or near the touch screen.

The proximity sensor 141, for example, can include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this situation, the touch screen (touch sensor) can also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 can sense proximity touch, and proximity touch patterns (e.g., distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the user terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor can be configured to convert changes of pressure applied to a specific part of the display unit 151, or convert capacitance occurring at a specific part of the display unit 151, into electric input signals. The touch sensor can also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals can be transmitted to a touch controller. The touch controller can process the received signals, and then transmit corresponding data to the controller 180. Accordingly, the controller 180 can sense which region of the display unit 151 has been touched. Here, the touch controller can be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input can be decided based on a current operating state of the user terminal 100 or a currently executed application program, for example.

The touch sensor and the proximity sensor can be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor can be implemented to recognize position information relating to a touch object using ultrasonic waves. The controller 180, for example, can calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source can be calculated using this fact. For instance, the position of the wave generation source can be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor can allow detection of a touch of a physical object with respect to a 3D stereoscopic image. The photo sensor can be laminated on, or overlapped with, the display device. The photo sensor can be configured to scan movement of the physical object in proximity to the touch screen. In more detail, the photo sensor can include photo diodes and transistors at rows and columns to scan content received at the photo sensor using an electrical signal which changes according to the quantity of applied light. Namely, the photo sensor can calculate the coordinates of the physical object according to variation of light to thus obtain position information of the physical object.

The display 151 is generally configured to output information processed in the user terminal 100. For example, the display 151 can display execution screen information of an application program executing at the user terminal 100 or user interface (UI) and graphic user interface (GUI) information in response to the execution screen information.

In some embodiments, the display 151 can be implemented as a stereoscopic display for displaying stereoscopic images.

A stereoscopic display can employ a stereoscopic display scheme such as a stereoscopic scheme (a glass scheme), an auto-stereoscopic scheme (glassless scheme), a projection scheme (holographic scheme), or the like.

The audio output module 152 (e.g., one or more speakers) is generally configured to output audio data. Such audio data can be obtained from any of a number of different sources, such that the audio data can be received from the wireless communication unit 110 or can have been stored in the memory 170. The audio data can be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the user terminal 100. The audio output module 152 can also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 can output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 can be provided according to the particular configuration of the user terminal 100.

An optical output module 154 can output a signal for indicating an event generation using light of a light source. Examples of events generated in the user terminal 100 can include message reception, call signal reception, a missed call, an alarm, a schedule notice, an email reception, information reception through an application, and the like.

A signal output by the optical output module 154 can be implemented in such a manner that the user terminal emits monochromatic light or light with a plurality of colors. The signal output can be terminated as the user terminal senses that a user has checked the generated event, for example.

The interface unit 160 serves as an interface for external devices to be connected with the user terminal 100. For example, the interface unit 160 can receive data transmitted from an external device, receive power to transfer to elements and components within the user terminal 100, or transmit internal data of the user terminal 100 to such external device. The interface unit 160 can include wired or wireless headset ports, external power supply ports, wired or wireless data ports, memory card ports, ports for connecting a device having an identification module, audio input/output (I/O) ports, video I/O ports, earphone ports, or the like.

The identification module can be a chip that stores various information for authenticating authority of using the user terminal 100 and can include a user identity module (UIM), a subscriber identity module (SIM), a universal subscriber identity module (USIM), and the like. In addition, the device having the identification module (also referred to herein as an “identifying device”) can take the form of a smart card. Accordingly, the identifying device can be connected with the terminal 100 via the interface unit 160.

When the user terminal 100 is connected with an external cradle, the interface unit 160 can serve as a passage to allow power from the cradle to be supplied to the user terminal 100 or can serve as a passage to allow various command signals input by the user from the cradle to be transferred to the user terminal there through. Various command signals or power input from the cradle can operate as signals for recognizing that the user terminal is properly mounted on the cradle.

The memory 170 can store programs to support operations of the controller 180 and store input/output data (for example, phonebook, messages, still images, videos, etc.). The memory 170 can store data related to various patterns of vibrations and audio which are output in response to touch inputs on the touch screen.

The memory 170 can include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The user terminal 100 can also be operated in relation to a network storage device that performs the storage function of the memory 170 over a network, such as the Internet.

The controller 180 can typically control the general operations of the user terminal 100. For example, the controller 180 can set or release a lock state for restricting a user from inputting a control command with respect to applications when a status of the user terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the user terminal 100. The power supply unit 190 can include a battery, which is typically rechargeable or be detachably coupled to the terminal body for charging.

The power supply unit 190 can include a connection port. The connection port can be configured as one example of the interface unit 160 to which an external charger for supplying power to recharge the battery is electrically connected.

As another example, the power supply unit 190 can be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein can be implemented in a computer-readable medium, a machine-readable medium, or similar medium using, for example, software, hardware, or any combination thereof.

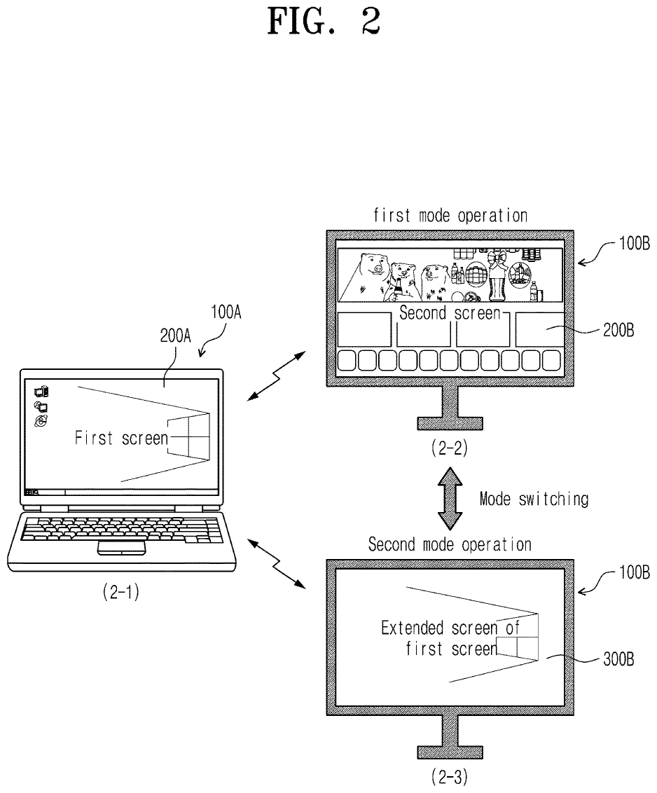

With further reference to FIG. 2, it will be described that a user terminal configured as described above can be communicatively connected to other user terminals. FIG. 2 illustrates a plurality of user terminals communicatively connected to each other according to an aspect of the present disclosure.

One of the plurality of user terminals in FIG. 2 will be referred to as a first user terminal 100A and the other as a second user terminal 100B. Each of the first user terminal 100A and the second user terminal 100B can correspond to the user terminal 100 described with reference to FIG. 1.

It is assumed that the first user terminal 100A is a personal computer such as a laptop, and the second user terminal 100B is a smart monitor. This is merely an example, to which the first user terminal 100A and the second user terminal 100B are not limited. For example, the first user terminal 100A can be a mobile terminal such as a smartphone or tablet, and the second user terminal 100B can be a TV. Alternatively, the first user terminal 100A can be a smart monitor, and the second user terminal 100B can be a personal computer.

Hereinafter, the name of each component of the first user terminal 100A will be preceded by “first” and its reference numeral appended with A, while the name of each component of the second user terminal 100B will be preceded by “second” and its reference numeral appended with B. For example, a controller of the first user terminal 100A will be denoted as a first controller 180A, and a controller of the second user terminal 100B will be denoted as a second controller 180B.

The first user terminal 100A can be connected to the second user terminal 100B through wired communication. The wired communication connection can be implemented by, for example (but not limited to), one of an HDMI scheme, a USB scheme, a Thunderbolt scheme, a DisplayPort method, and so on

Alternatively, the first user terminal 100A can be connected to the second user terminal 100B through wireless communication. The wireless communication connection can be implemented by, for example (but not limited to), one of a Bluetooth scheme, an ultra-wideband (UWB) scheme, a Miracast scheme, an AirPlay scheme, and so on.

The first user terminal 100A and the second user terminal 100B can be driven by different operating systems. For example, the first user terminal 100A can be a personal computer and driven by an operating system (hereinafter, a first operating system) such as Microsoft Windows or Apple macOS. The second user terminal 100B can be a smart monitor and driven by an operating system (a second operating system) such as Linux-based webOS. The first operating system of the first user terminal 100A does not necessarily have to be different from the second operating system of the second user terminal 100B. The first operating system of the first user terminal 100A can be the same as the second operating system of the second user terminal 100B.

The first user terminal 100A can operate as a main device. Accordingly, as illustrated in 2-1 of FIG. 2, the first user terminal 100A can display its own screen based on the first operating system of the first user terminal 100A, that is, a first screen 200A on a first display 151A.

The second user terminal 100B, which is communicatively connected to the first user terminal 100A, can operate as another main device when operating in a first mode, and can operate as a sub-device of the first user terminal 100A when operating in a second mode.

When the second user terminal 100B operates as a main device, it can display its own screen based on the second operating system of the second user terminal 100B, that is, a second screen 200B on a second display 151B, as illustrated in 2-2 of FIG. 2.

When the second user terminal 100B operates as a sub-device, it can receive an extended screen or a duplicated screen 300B of the first screen 200A from the first user terminal 100A through a communication connection and display it on the second display 151B, as illustrated in 2-3 of FIG. 2. The extended screen refers to a screen connected in one direction of the first screen 200A, and the duplicated screen can refer to a screen identical to the first screen 200A. Hereinafter, it will be assumed and described that the second user terminal 100B displays an extended screen of the first screen 200A of the first user terminal 100A, when operating as a sub-device.

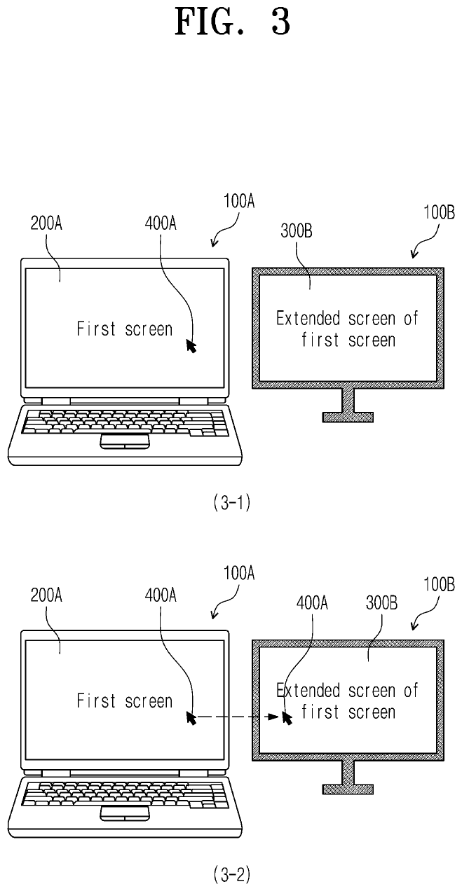

Hereinafter, a situation where the second user terminal 100B operates as a sub-device will be described with reference to FIG. 3. FIG. 3 illustrates an example in which a user terminal operates as a sub-device according to an aspect of the present disclosure.

As illustrated in 3-1 of FIG. 3, the first user terminal 100A can display a first pointer or cursor 400A on the first screen 200A. The first pointer 400A can be generated by the first user terminal 100A and controlled by a first input device (e.g., a first user input unit 123A) of the first user terminal 100A. An example of the first input device can include at least one of a keyboard, a mouse, or a touchpad. The first input device can be built into the first user terminal 100A or can be external to be communicatively connected to the first user terminal 100A. A user can input a user command to the first user terminal 100A by controlling the first pointer 400A using the first input device. For example, the user can use the first input device to move the first pointer 400A onto any clickable graphic object (e.g., an icon, a menu, a link, a text input box, or the like) on the first screen 200A to select (e.g., click) a desired graphic object.

As illustrated in 3-2 of FIG. 3, when the second user terminal 100B operates as a sub-device, it can display the extended screen 300B of the first screen 200A of the first user terminal 100A.

Accordingly, the user can control the first pointer 400A to move from the first screen 200A to the extended screen 300B, using the first input device. Even when the first pointer 400A is on the extended screen 300B, the user can input a user command to the first user terminal 100A by controlling the first pointer 400A, still using the first input device. For example, the user can select a desired graphic object by moving the first pointer 400A onto any clickable graphic object (e.g., an icon, a menu, a link, a text input box, or the like) on the extended screen 300B, using the first input device. For example, using the first user terminal 100A as a first input device, the user can seamlessly move a first pointer 400A between the first screen 200A and the extended screen 300B to interact with graphic objects (e.g., icons, menus, or text boxes) and input commands via the first user terminal 100A.

The aforementioned communication connection through which the first user terminal 100A transmits the extended screen 300B of the first screen to the second user terminal 100B will be referred to as a first communication connection.

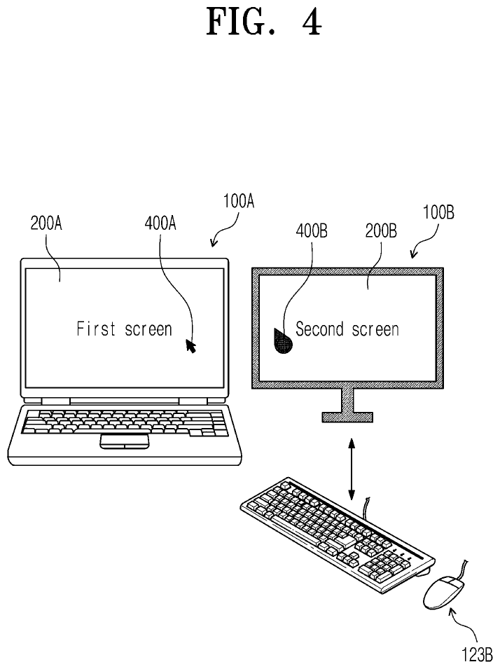

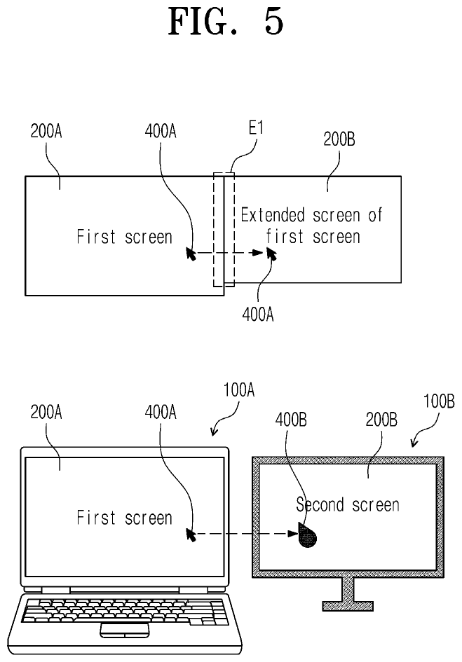

Hereinafter, a situation where the second user terminal 100B operates as another main device will be described with reference to FIGS. 4 and 5. FIGS. 4 and 5 illustrate examples in which a user terminal operates as a main device according to an aspect of the present disclosure.

As illustrated in FIG. 4, the first user terminal 100A can display the first pointer or cursor 400A on the first screen 200A, and the user can control the first pointer 400A to input a user command to the first user terminal 100A, using the first input device, as described before. For example, the user can select a desired graphic object by moving the first pointer 400A onto any clickable graphic object (e.g., an icon, a menu, a link, a text input box, or the like) on the first screen 200A, using the first input device.

The second user terminal 100B can display a second pointer or cursor 400B on the second screen 200B. The second pointer 400B can be generated by the second user terminal 100B and controlled by a second input device (e.g., a second user input unit 123B) of the second user terminal 100B. An example of the second input device can include at least one of a keyboard, a mouse, or a touchpad. The second input device can be built into the second user terminal 100B or can be external to be communicatively connected to the second user terminal 100B. The user can control the second pointer 400B using the second input device to input a user command to the second user terminal 100B. For example, the user can use the second input device to move the second pointer 400B onto any clickable graphic object (e.g., an icon, a menu, a link, a text input box, or the like) on the second screen 200B to select a desired graphic object.

In this situation, however, there is a disadvantage in that the second user terminal 100B should also be equipped with a separate second input device. Moreover, there is the inconvenience that the user should use the first input device when entering a user command into the first user terminal 100A, and use the second input device when entering a user command into the second user terminal 100B. For example, when entering a command into the first user terminal 100A, the user should control the first pointer 400A using the first input device, and when entering a command into the second user terminal 100B, the user should control the second pointer 400B using the second input device. For example, as shown in FIG. 4 as a comparative example, a user must inconveniently switch between using a first input device to control a first pointer 400A on the first screen 200A, and using a separate second input device 123B to control a second pointer 400B on the second screen 200B.

To resolve such inconvenience, it can be considered to allow the user to input a user command to the second user terminal 100B using the first input device of the first user terminal 100A, even when the second user terminal 100B operates as another main device. This will be described with reference to FIG. 5.

For example, as illustrated in FIG. 5, the first user terminal 100A can generate the first screen 200A and its extended screen 300B. The size of the extended screen 300B of the first screen 200A can be determined based on a display resolution in display identification data received from the second user terminal 100B. The first user terminal 100A can display the first screen 200A and transmit the extended screen 300B to the second user terminal 100B through the first communication connection. However, since the second user terminal 100B is operating as a main device, it can display the second screen 200B instead of the extended screen 300B. The extended screen 300B can correspond to a virtual screen for the second user terminal 100B.

For example, as illustrated in FIG. 5, the first terminal 100A can generate a first screen 200A and an extended screen 300B based on display identification data received from the second terminal 100B. Because the second terminal 100B operates as a main device, it displays its own second screen 200B instead of the transmitted extended screen 300B. Consequently, the extended screen 300B can function strictly as an invisible virtual screen, e.g., acting as a coordinate grid within the memory of the first terminal 100A to track pointer movements intended for the second terminal 100B, according to an embodiment.

As described before, the first user terminal 100A can display the first pointer or cursor 400A on the first screen 200A, allowing the user to control the first pointer 400A using the first input device to input a user command to the first user terminal 100A.

The user can use the first input device (e.g., a mouse, touch pad, or the like) to control the first pointer 400A to move from the first screen 200A toward the second screen 200B (or the extended screen 300B). For example, when the user uses the first input device to control the first pointer 400A to pass through an edge region E1 (e.g., a right edge region) of the first screen 200A (e.g., an input routing condition being met), the first user terminal 100A can control the first pointer 400A to disappear from the first screen 200A beyond the edge region E1. Along with this, the first user terminal 100A can transmit information about virtual coordinates of the first pointer 400A on a virtual screen beyond the edge region in the first screen 200A to the second user terminal 100B. Since the virtual screen is determined based on the display resolution in the display identification data received from the second user terminal 100B, it can correspond to the second screen 200B in terms of display coordinates. It can serve as a reference, that is, a coordinate system for the virtual coordinates of the virtual screen.

The second user terminal 100B can then receive the information about the virtual coordinates of the first pointer 400A and generate and display the second pointer 400B at a position corresponding to the virtual coordinates of the first pointer 400A on the second screen 200B.

It can appear to the user that the first pointer 400A moves to the right on the first screen 200A and disappears as soon as it passes the right edge region E1, at which point the second pointer 400B emerges from the left side of the second screen 200B and moves to the right.

In other words, when the user moves the first pointer 400A past an edge of the first screen 200A, the pointer 400A disappears from view. At this point, the first terminal 100A begins tracking the pointer 400A within an invisible “virtual screen” and transmits these virtual coordinates to the second terminal 100B. Because this virtual screen is generated using the specific display resolution of the second terminal 100B, the transmitted virtual coordinates map perfectly to the physical display area of the second screen 200B, allowing the second terminal 100B to generate and display a corresponding second pointer 400B.

The user can select (e.g., click) a desired graphic object by moving the second pointer 400B onto any clickable graphic object (e.g., an icon, a menu, a link, a text input box, or the like) on the second screen 200B using the first input device 123A rather than the second input device 123B. While the second pointer 400B is located on the graphic object on the second screen 200B, when the first input device receives a selection command (e.g., a click command) for the graphic object from the user, the first user terminal 100A can transmit the selection command to the second user terminal 100B. The second user terminal 100B can receive the selection command and perform an operation according to the selection command for that graphic object.

When the graphic object is a text input box, a typing command (e.g., a search word) input by the user through the first input device (e.g., a keyboard) after the selection command can be transmitted from the first user terminal 100A to the second user terminal 100B. The second user terminal 100B can receive the typing command and perform an operation according to the typing command for that text input box. For example, when the text input box is a search input box, the second user terminal 100B can perform a search operation corresponding to the search word.

For example, using the first terminal 100A as an input device, a user can position the second pointer 400B to interact with graphic objects on the second screen 200B. When the user inputs a command (e.g., a mouse click or typing) the first terminal 100A can transmit the command to the second terminal 100B. The second terminal 100B can then receive and execute the corresponding operation locally.

At least one of the virtual coordinate information, the selection command, or the typing command described above can be transmitted through the second communication connection separate from the first communication connection between the first user terminal 100A and the second user terminal 100B. In other words, according to an embodiment, the system can utilize two distinct communication connections to optimize data transfer. The first communication connection can include a wired interface (e.g., HDMI or USB-C) configured to transmit high-bandwidth screen data. The second communication connection can include a separate wireless interface (e.g., Wi-Fi or Bluetooth) dedicated to transmitting control data, such as virtual coordinate information, selection commands, and typing commands. Separating these data paths can prevent control signals from consuming the bandwidth of the video transmission while enabling the second terminal to securely receive control inputs over an independent network. However, embodiments are not limited thereto and the first and second communication connection can be two separate wireless connections, e.g., using different protocols.

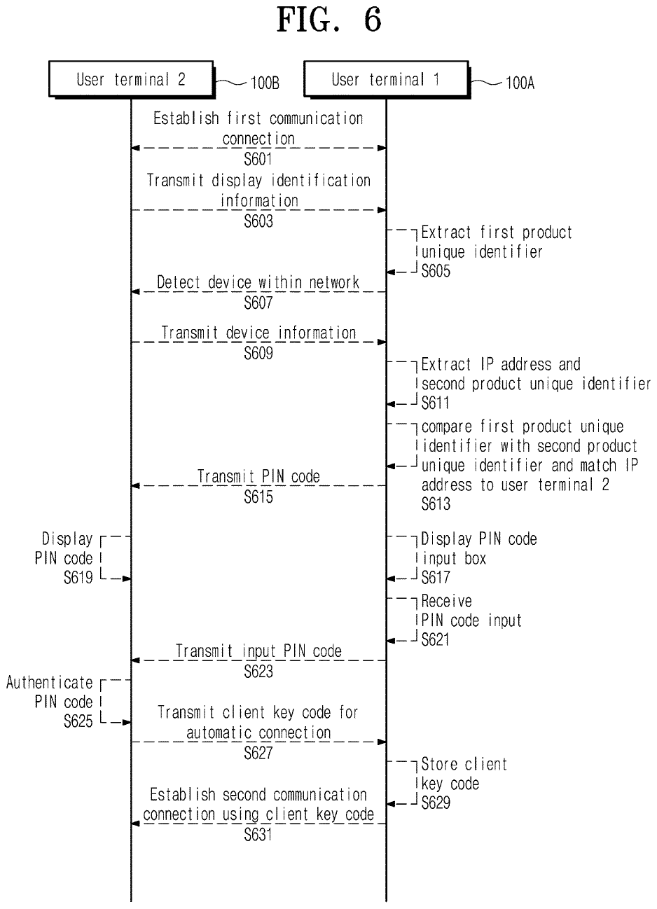

With reference to FIG. 6, establishment of the second communication connection between the first user terminal 100A and the second user terminal 100B will be described below. FIG. 6 illustrates a communication connection process between a plurality of user terminals according to an aspect of the present disclosure.

For simplicity, the following description is given with the appreciation that the first user terminal 100A and the second user terminal 100B are operation entities. However, at least one component (e.g., the first controller 180A) of the first user terminal 100A and at least one other component (e.g., the second controller 180B) of the second user terminal 100B can be operation entities in practice.

It is assumed that the first user terminal 100A and the second user terminal 100B are connected to the same wireless network. For example, the first user terminal 100A and the second user terminal 100B can be connected to the same access point (AP). Alternatively, one of the first user terminal 100A and the second user terminal 100B can be connected to a soft AP provided by the other. A soft AP refers to software implemented as a wireless AP by a user terminal, such that it operates as another AP for other terminals and/or home appliances.

The first user terminal 100A can be a personal computer such as a laptop and the second user terminal 100B can be a smart monitor, but they are not limited thereto. Further, the first user terminal 100A can be a smart monitor, and the second user terminal 100B can be a personal computer such as a laptop.

First, the first communication connection between the first user terminal 100A and the second user terminal 100B can be established [S601]. For example, a wired communication connection can be established between the first user terminal 100A and the second user terminal 100B through one of (but not limited) to an HDMI scheme, a USB scheme, and a Thunderbolt scheme. Alternatively, a wireless communication connection can be established between the first user terminal 100A and the second user terminal 100B through one of (but not limited to) a Bluetooth scheme, a UWB scheme, a Miracast scheme, and an AirPlay scheme.

Once the first communication connection is established between the first user terminal 100A and the second user terminal 100B, the first user terminal 100A can receive extended display identification data (EDID) from the second user terminal 100B [S603]. The display identification data can include display specification information about at least one of the manufacturer, model name, product unique identifier, display size, or display resolution of the user terminal. The product unique identifier can include, for example, a product serial number.

The first user terminal 100A can extract the product unique identifier from the display identification data of the second user terminal 100B [S605]. The product unique identifier extracted from the display identification data will be referred to as a first product unique identifier.

The first user terminal 100A can search for at least one other device, including the second user terminal 100B, within the wireless network [S607]. For example, upon connecting to the wireless network, the first user terminal 100A can search for other devices in the wireless network based on the universal plug and play (UPnP) and/or simple service discovery protocol (SSDP).

The first user terminal 100A can receive its device information from at least one other device including the second user terminal 100B [S609]. The device information can include an IP address and a product unique identifier.

The first user terminal 100A can extract the IP address and the product unique identifier from the device information [S611]. The product unique identifier extracted from the device information will be referred to as a second product unique identifier.

Steps S607 to S611 can be performed before steps S601 to S605 or in parallel with steps S601 to S605 in time.

The first user terminal 100A can compare the first product unique identifier with the second product unique identifier, and match the IP address extracted with the second product unique identifier identical to the first product unique identifier to the second user terminal 100B [S613]. That is, the first user terminal 100A can recognize that the extracted IP address is one assigned to the second user terminal 100B within the wireless network.

Although the first user terminal can establish the second communication connection immediately using the extracted IP address, it can perform the following PIN code authentication to increase the reliability of the second communication connection, according to an embodiment.

That is, the first user terminal 100A can generate a PIN code for the second user terminal 100B and transmit the PIN code to the second user terminal 100B within the wireless network, using the extracted IP information [S615].

Then, the first user terminal 100A can display an input box for the user to enter a PIN code [S617].

The second user terminal 100B can receive and display the PIN code [S619].

The user can view the PIN code displayed on the second user terminal 100B and enter the PIN code into the input box displayed on the first user terminal 100A [S621].

The first user terminal 100A can transmit the entered PIN code back to the second user terminal 100B [S623].

The second user terminal 100B can perform PIN code authentication using the PIN code received back from the first user terminal 100A [S625]. For example, the second user terminal 100B can determine whether the PIN code displayed in step S619 is identical to the PIN code received in step S623.

When the PIN codes are identical, the second user terminal 100B can generate a client key code for automatic connection and transmit it to the first user terminal 100A [S627].

The first user terminal 100A can receive the client key code and store it for future automatic connection with the second user terminal 100B [S629].

The first user terminal 100A can establish the second communication connection with the second user terminal 100B over the wireless network using the stored client key code [S631]. The second communication connection can be a Wi-Fi communication connection.

In the future, even if the second communication connection to the second user terminal 100B is disconnected, the first user terminal 100A can immediately establish the second communication connection on the wireless network by performing only step S631 using the stored client key code, without repeating steps S601 to S629.

The first user terminal 100A and the second user terminal 100B can communicate with each other over the wireless network through a secure web socket scheme as the second communication connection.

In other words, after establishing the first communication connection [S601], the first terminal 100A can extract a product identifier from the received display identification data (EDID) [S603, S605]. Concurrently or sequentially, the first terminal 100A can search a wireless network [S607-S611] and match the extracted EDID identifier with a discovered network identifier to locate the specific IP address of the second terminal 100B on the network [S613].

Then, to secure the second communication connection, the devices can perform a PIN authentication process [S615-S625]. A PIN generated by the first terminal 100A can be transmitted to and displayed on the second terminal 100B, which the user can then enter back into the first terminal 100A for verification. Upon successful authentication, the second terminal 100B can provide a client key code [S627, S629]. The first terminal 100A can store this key code to establish the second communication connection (e.g., via a secure web socket over Wi-Fi) [S631], which can also enable automatic network reconnections in the future without repeating the PIN authentication process. Also, a PIN code is just an example and other authentication mechanisms can be uses to secure the connection, according to embodiments, such as Quick Response (QR) codes, alphanumeric passwords, biometric verification, or Near Field Communication (NFC) protocols.

Also, the first user terminal 100A can also establish first and second communication connections with one or more other user terminals as described above, while maintaining the first and second communication connections with the second user terminal 100B (e.g., for controlling multiple displays via one device, etc.).

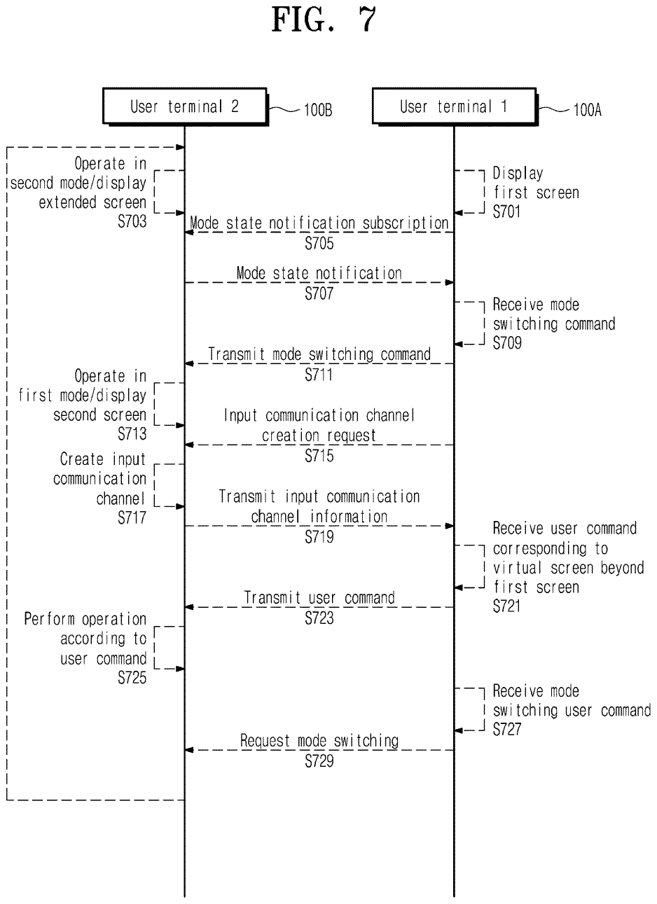

With reference to FIG. 7, a description will be given regarding how the first user terminal 100A controls all switching between the first mode and the second mode of the second user terminal 100B, when both the first and second communication connections are established. FIG. 7 illustrates a mode switching process of a user terminal according to an aspect of the present disclosure.

While operating as a main device, the first user terminal 100A can display the first screen 200A [S701].

The second user terminal 100B can operate in the second mode to function as a sub-device of the first user terminal 100A [S703]. Accordingly, the second user terminal 100B can receive the extended screen 300B of the first screen 200A from the first user terminal 100A and display it [S703].

The first user terminal 100A can subscribe to mode state notifications from the second user terminal 100B [S705].

In response to receiving the mode state notification subscription, the second user terminal 100B can transmit a mode state notification regarding its current mode to the first user terminal 100A periodically and/or whenever its mode is switched [S707].

The first user terminal 100A can recognize the current mode of the second user terminal 100B by receiving the mode state notification from the second user terminal 100B.

While FIG. 7 illustrates that the second user terminal 100B performs step S707 in response to the mode state notification subscription from the first user terminal 100A, the second user terminal 100B can also be configured to perform step S707 by default once the second communication connection is established with the first user terminal 100A.

The first user terminal 100A can receive a mode switching command for the second user terminal 100B from the user through the first input device 123A [S709].

The first user terminal 100A can transmit the mode switching command to the second user terminal 100B [S711].

In response to the mode switching command received from the first user terminal 100A, the second user terminal 100B can switch from the second mode to the first mode and operate as another main device [S713]. Accordingly, the second user terminal 100B can display the second screen 200B.

To control the second user terminal 100B operating in the first mode, the first user terminal 100A can transmit a request for creating an input communication channel to the second user terminal 100B in order to transmit a user command input through the first input device 123A of the first user terminal 100A [S715].

In response to the request for creating an input communication channel from the first user terminal 100A, the second user terminal 100B can create an input communication channel and transmit information about the input communication channel to the first user terminal 100A [S717 and S719].

The first user terminal 100A can receive a user command for the second user terminal 100B through the first input device 123A [S721]. The user command for the second user terminal 100B can include at least one of virtual coordinate information, a selection command, or a typing command described before.

The first user terminal 100A can transmit the user command to the second user terminal 100B through the input communication channel [S723].

The second user terminal 100B can perform an operation according to the user command [S725].

The first user terminal 100A can receive a mode switching command for the second user terminal 100B from the user through the first input device 123A [S727].

The first user terminal 100A can transmit the mode switching command to the second user terminal 100B [S729].

In response to the mode switching command received from the first user terminal 100A, the second user terminal 100B can switch from the first mode back to the second mode and operate as a sub-device of the first user terminal 100A [S703].

In other words, the first terminal 100A can monitor the operating mode of the second terminal 100B via state notifications [S705, S707]. Initially, the second terminal 100B operates in a second mode as a sub-device, displaying an extended screen 300B [S701, S703]. However, the user can input a mode switching command via the first input device 123A to switch the second terminal 100B into a first mode, in which the second terminal 100B operates as an independent main device displaying its own second screen 200B [S709-S713].

Upon switching to this first mode, the terminals can establish a dedicated input communication channel [S715-S719]. This channel can enable the first terminal 100A to transmit user commands (e.g., virtual coordinates, selections, or typing) for local execution by the second terminal 100B [S721-S725]. A subsequent switching command can revert the second terminal 100B back to the sub-device mode [S727-S729, S703]. These control signals and mode switches can be transmitted over either the first or second communication connection.

For example, according to an embodiment, the first terminal is configured to dynamically toggle the second terminal between a sub-device mode and a main device mode. In the sub-device mode, the second terminal can function passively as an external display to output an extended screen provided by the first terminal. Upon receiving a mode switching command, the second terminal can transition to the main device mode, in which the second terminal actively executes and displays its own independent operating system. To maintain unified control while the second terminal operates in the main device mode, the terminals can establish a dedicated input communication channel. This channel can seamlessly transmit input commands (e.g., cursor movements, clicks, and keystrokes) captured by the first terminal's input device directly to the second terminal for local execution.

While steps S705, S707, S711, S715, S719, S723, and S709 in FIG. 7 can be performed through the second communication connection between the first user terminal 100A and the second user terminal 100B, at least one of these can also be performed through the first communication connection between the first user terminal 100A and the second user terminal 100B. For example, the second terminal 100B can operate in a first mode (e.g., which can be referred to as a native execution mode), in which the second terminal 100B actively executes and displays its own independent operating system, or a second mode (e.g., which can be referred to as a passive display mode), in which the second terminal 100B functions as an external display to output an extended screen provided by the first terminal 100A.

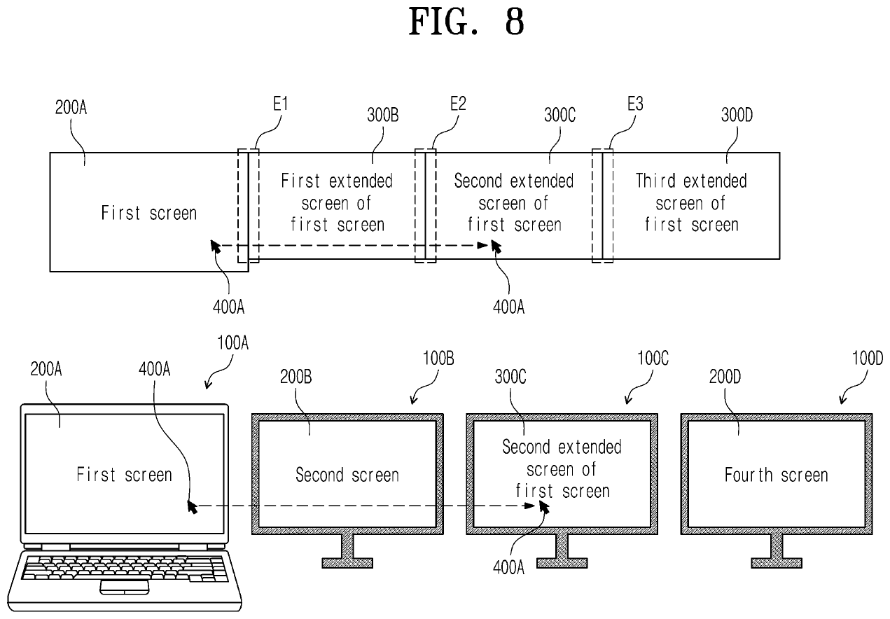

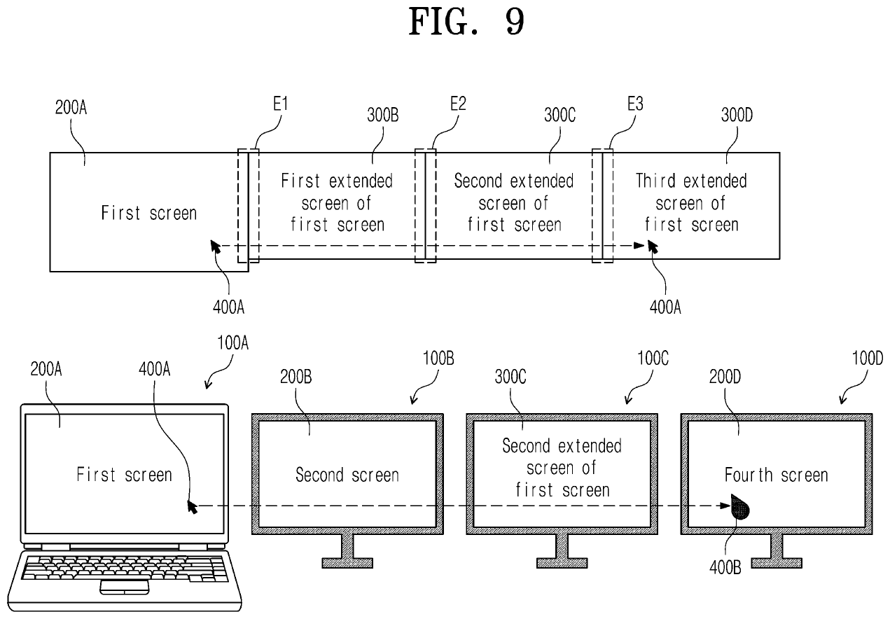

A situation where the first user terminal 100A is connected through the first and second communication connections to another user terminal, that is, the second user terminal 100B capable of switching between the first and second modes has been described above. Hereinafter, a situation where the first user terminal 100A is connected through first and second communication connections to a plurality of other user terminals capable of switching between the first and second modes will be described with further reference to FIGS. 8 and 9. FIGS. 8 and 9 illustrate a plurality of user terminals communicatively connected to each other according to an aspect of the present disclosure.

In FIGS. 8 and 9, it is assumed that the first user terminal 100A is connected through first and second communication connections to three other user terminals, that is, the second user terminal 100B, a third user terminal 100C, and a fourth user terminal 100D, each capable of switching between the first and second modes. It can be understood that the first user terminal 100A serves as a host device, while the second user terminal 100B, the third user terminal 100C, and the fourth user terminal 100D operate as client devices.

It is assumed that the first user terminal 100A, the second user terminal 100B, the third user terminal 100C, and the fourth user terminal 100D are arranged from left to right. The relative position of each of the second user terminal 100B, the third user terminal 100C, and the fourth user terminal 100D with respect to the first user terminal 100A can be set through the first user terminal 100A by the user.

As illustrated in FIG. 8, the first user terminal 100A can generate the first screen 200A and a first extended screen 300B, a second extended screen 300C, and a third extended screen 300D of the first screen 200A. Since the first user terminal 100A, the second user terminal 100B, the third user terminal 100C, and the fourth user terminal 100D are arranged from left to right, the first screen 200A, the first extended screen 300B, the second extended screen 300C, and the third extended screen 300D can also be generated to be arranged from left to right accordingly.

The size of the first extended screen 300B can be determined based on display resolution in display identification data received from the second user terminal 100B, the size of the second extended screen 300C can be determined based on a display resolution in display identification data received from the third user terminal 100C, and the size of the third extended screen 300D can be determined based on a display resolution in display identification data received from the fourth user terminal 100D.

The first user terminal 100A can display the first screen 200A.

The first user terminal 100A can transmit the first extended screen 300B to the second user terminal 100B through the first communication connection between the first user terminal 100A and the second user terminal 100B. The first extended screen 300B can correspond to a first virtual screen for the second user terminal 100B.

The first user terminal 100A can transmit the second extended screen 300C to the third user terminal 100C through a first communication connection between the first user terminal 100A and the third user terminal 100C. The second extended screen 300C can correspond to a second virtual screen for the third user terminal 100C.

The first user terminal 100A can transmit the third extended screen 300D to the fourth user terminal 100D through a first communication connection between the first user terminal 100A and the fourth user terminal 100D. The third extended screen 300D can correspond to a third virtual screen for the fourth user terminal 100D.

In FIGS. 8 and 9, the second user terminal 100B is operating as a main device, by way of example. Accordingly, the second user terminal 100B can display the second screen 200B instead of the first extended screen 300B. The second screen 200B can be a screen based on the operating system of the second user terminal 100B.

In FIGS. 8 and 9, the third user terminal 100C is operating as a sub-device of the first user terminal 100A, by way of example. Accordingly, the third user terminal 100C can display the second extended screen 300C.

In FIGS. 8 and 9, the fourth user terminal 100D is operating as a main device, by way of example. Accordingly, the fourth user terminal 100D can display a fourth screen 200D instead of the third extended screen 300D. The fourth screen 200D can be a screen based on the operating system of the fourth user terminal 100D.

As described before, the first user terminal 100A can display the first pointer or cursor 400A on the first screen 200A, and the user can enter a user command into the first user terminal 100A by controlling the first pointer 400A using the first input device.

As described before with reference to FIG. 5, the user can control the second user terminal 100B by causing the second pointer 400B to be displayed on the second screen 200B of the second user terminal 100B, using the first input device 123A of the first user terminal 100A.

With reference to FIG. 8, a situation where the user operates the first input device 123A to move the first pointer 400A on the first screen 200A to the second extended screen 300C will be described below.

The user can use the first input device (e.g., a mouse, a touch pad, or the like) to control the first pointer 400A to move from the first screen 200A through the first extended screen or first virtual screen 300B toward the second extended screen or second virtual screen 300C.

For example, when the user uses the first input device to control the first pointer 400A to pass through the first edge region E1 between the first screen 200A and the first extended screen 300B and a second edge region E2 between the first extended screen 300B and the second extended screen 300C, the first user terminal 100A can control the first pointer 400A to disappear from the first screen 200A beyond the edge region E1.

As described before with reference to FIG. 5, while the first pointer 400A passes through the first extended screen 300B, the second pointer 400B can be displayed on the second screen 200B of the second user terminal 100B to correspond to the virtual coordinates of the first pointer 400A on the first virtual screen 300B. Accordingly, while the first pointer 400A passes through the first extended screen 300B, the second pointer 400B can be displayed to pass across the second screen 200B of the second user terminal 100B in a manner corresponding to the first pointer 400A.

When the first pointer 400A is located within the second extended screen 300C, the first user terminal 100A can transmit the second extended screen 300C displaying the first pointer 400A to the third user terminal 100C, and the third user terminal 100C can display the second extended screen 300C displaying the first pointer 400A.

With reference to FIG. 9, a situation where the user operates the first input device 123A to move the first pointer 400A on the first screen 200A to the third extended screen 300D will be described below.

The user can use the first input device (e.g., a mouse, a touch pad, or the like) to control the first pointer 400A to move from the first screen 200A, sequentially through the first extended screen or first virtual screen 300B and the second extended screen or second virtual screen 300C, toward the third extended screen or third virtual screen 300D.

For example, when the user uses the first input device to control the first pointer 400A to pass through the first edge region E1 between the first screen 200A and the first extended screen 300B, the second edge region E2 between the first extended screen 300B and the second extended screen 300C, and a third edge region E3 between the second extended screen 300C and the third extended screen 300D, the first user terminal 100A can control the first pointer 400A to disappear from the first screen 200A beyond the edge region E1.

As described before with reference to FIG. 5, while the first pointer 400A passes through the first extended screen 300B, the second pointer 400B can be displayed on the second screen 200B of the second user terminal 100B, instead of the first pointer 400A, to correspond to the virtual coordinates of the first pointer 400A on the first virtual screen 300B. Accordingly, while the first pointer 400A passes through the first extended screen 300B, the second pointer 400B can be displayed to pass across the second screen 200B of the second user terminal 100B in a manner corresponding to the first pointer 400A.

As described before with reference to FIG. 8, while the first pointer 400A passes through the second extended screen 300C, the first pointer 400A can be displayed on the second extended screen 300C of the third user terminal 100C. Accordingly, the first pointer 400A can be displayed to pass across the second extended screen 300C of the third user terminal 100C.

When the first pointer 400A is located within the third extended screen 300D, the first user terminal 100A can transmit information about the virtual coordinates of the first pointer 400A within the third virtual screen 300D to the fourth user terminal 100D. Since the third virtual screen 300D is determined based on the display resolution in the display identification data received from the fourth user terminal 100D, it can correspond to the fourth screen 200D in terms of display coordinates.

Then, the fourth user terminal 100D can receive the information about the virtual coordinates of the first pointer 400A and generate and display the second pointer 400B at a position corresponding to the virtual coordinates of the first pointer 400A on the fourth screen 200D.

It can appear to the user that the first pointer 400A moves to the right on the second extended screen 300C and disappears as soon as it passes the third edge region E3, at which point the second pointer 400B emerges from the left side of the fourth screen 200D and move to the right.

As described before with reference to FIG. 5, the user can control the second pointer 400B within the fourth screen 200D through the first input device 123A of the first user terminal 100A, and control the fourth user terminal 100D through the first input device 123A and the second pointer 400B.

In other words, referring to FIGS. 8 and 9, according to an embodiment, the first terminal 100A can be communicatively coupled to a plurality of external terminals (e.g., second, third, and fourth terminals 100B, 100C, 100D) arranged in a sequential spatial order. To facilitate this multi-device environment, the first terminal 100A can generate a corresponding extended screen 300B, 300C, 300D for each respective external terminal, sized according to their individual display identification data.

In this example embodiment, the second terminal 100B and fourth terminal 100D are operating in the native execution mode (e.g., first mode), thereby displaying their own independent operating system screens 200B, 200D. Consequently, the first and third extended screens 300B, 300D can function as invisible virtual screens used by the first terminal 100A for coordinate tracking. Conversely, the third terminal 100C is operating in the passive display mode (e.g., second mode), actively displaying the second extended screen 300C provided by the first terminal 100A.

Further in this example, when a user uses the first input device 123A of the first terminal 100A to move the first pointer 400A continuously across this sequential arrangement, the system can dynamically adapt the pointer output based on the operating mode of each traversed terminal.

For example, as the first pointer 400A traverses the virtual screens 300B and 300D, the first terminal 100A can transmit virtual coordinates to the second and fourth terminals 100B, 100D, causing them to natively render a corresponding pointer (e.g., second pointer 400B) on their independent screens.

However, when the pointer coordinates enter the second extended screen 300C, the first terminal 100A can simply render the first pointer 400A directly within the extended screen video feed transmitted to the passively operating third terminal 100C.

In this way, the framework can enable a single input device to seamlessly navigate and control a mixed environment of independent and passive terminals (e.g., a mix of terminals in which some are in the first mode and some are in the second mode).

The present disclosure described above can be implemented with computer-readable codes on a medium in which a program is recorded. Computer-readable media include all kinds of recording devices in which data readable by a computer system is stored. Examples of computer-readable media include a hard disk drive (HDD), a solid state disk (SSD), a silicon disk drive (SDD), a ROM, a RAM, a CD-ROM, a magnetic tape, a floppy disk, an optical data storage device, and the like. In addition, the computer can include a processor of an artificial intelligence device.

What is claimed is:

1. A method for controlling a main user terminal, the method comprising:
establishing a first communication connection between the main user terminal and an external user terminal for transmitting screen data;
establishing a second communication connection between the main user terminal and the external user terminal for transmitting control data;
in response to determining that an input routing condition is met for directing control to the external user terminal, obtaining an input event generated by an input device connected to the main user terminal; and
transmitting data corresponding to the input event from the main user terminal to the external user terminal via the second communication connection for enabling the external user terminal to execute an operation corresponding to the input event.

2. The method of claim 1, wherein the determining that the input routing condition is met includes determining that a pointer controlled by the input device passes through an edge region of a first screen displayed on the main user terminal.

3. The method of claim 2, further comprising:
generating an extended screen associated with the first screen, wherein the extended screen functions as a virtual screen within a memory of the main user terminal; and
generating virtual coordinates of the pointer within the virtual screen, wherein the data corresponding to the input event includes the virtual coordinates.

4. The method of claim 2, further comprising:
in response to determining that the pointer passes through the edge region, causing the pointer to disappear from the first screen of the main user terminal while the data corresponding to the input event is transmitted to the external user terminal.

5. The method of claim 1, wherein the first communication connection comprises a wired interface, and the second communication connection comprises a wireless interface utilizing a Bluetooth protocol or a Wi-Fi protocol.

6. The method of claim 1, further comprising:
requesting the external user terminal to create a dedicated input communication channel within the second communication connection; and
transmitting the data corresponding to the input event through the dedicated input communication channel.

7. The method of claim 1, wherein the input event includes at least one of a selection command or a typing command, and
wherein the external user terminal executes the operation locally based on the at least one of the selection command or the typing command.

8. The method of claim 1, wherein the external user terminal operates in a native execution mode to display an independent operating system screen while receiving the data corresponding to the input event from the main user terminal.

9. The method of claim 1, wherein the establishing the second communication connection includes:
performing an authentication process with the external user terminal over a wireless network; and
receiving a code from the external user terminal to secure the second communication connection.

10. A user terminal comprising:
an input device;
a display;
a communication unit configured to establish a first communication connection and a second communication connection with a first external user terminal; and
a controller configured to:
generate a first screen and an extended screen associated with the first screen;
display the first screen on the display;
transmit the extended screen to the first external user terminal through the first communication connection; and
transmit virtual coordinate information associated with the input device and a user command input through the input device to the first external user terminal through the second communication connection.

11. The user terminal of claim 10, wherein the controller is further configured to receive display identification data from the first external user terminal through the first communication connection.

12. The user terminal of claim 11, wherein the controller is further configured to control the generation of the extended screen based on a display resolution in the display identification data.

13. The user terminal of claim 11, wherein the controller is further configured to:
receive an Internet Protocol (IP) address and a product unique identifier of the first external user terminal from the first external user terminal through a wireless network; and
when the product unique identifier is identical to a product unique identifier in the display identification data, match the IP address to the first external user terminal.

14. The user terminal of claim 13, wherein the controller is further configured to:
perform personal identification number (PIN) code authentication with the first external user terminal using the IP address;
receive a client key code for automatic connection from the first external user terminal; and
establish the second communication connection with the first external user terminal using the client key code.

15. The user terminal of claim 10, wherein the controller is configured to:
receive a mode state notification from the first external user terminal;
when the first external user terminal is identified as operating as a main device through the mode state notification, request the first external user terminal to create an input communication channel in the second communication connection; and
transmit the virtual coordinate information associated with the input device and the user command input through the input device to the first external user terminal through the input communication channel.

16. The user terminal of claim 10, wherein the extended screen serves as a coordinate system for the virtual coordinate information.

17. The user terminal of claim 10, wherein the controller is further configured to establish a first communication connection and a second communication connection with a second external user terminal, while the first communication connection and the second communication connection are established with the first external user terminal.

18. The user terminal of claim 17, wherein the first communication connection is a high definition multimedia interface (HDMI) connection or a DisplayPort (DP) connection, and the second communication connection is a Wi-Fi communication connection.

19. A user terminal comprising:
an input device;
a display;
a communication unit configured to establish a first communication connection and a second communication connection with an external user terminal; and
a controller configured to:
when operating in a second mode, display an extended screen received from the external user terminal through the first communication connection on the display, wherein the extended screen is capable of including a first pointer; and
when operating in a first mode, display a second screen on the display, and generate and display a second pointer on the second screen based on virtual coordinate information received through the second communication connection.

20. The user terminal of claim 19, wherein the controller is further configured to create an input communication channel in response to an input communication channel creation request received from the external user terminal through the second communication connection, and transmit information about the input communication channel to the external user terminal.
